(19) United States
(12) Patent Application Publication
(10) Pub. No.: US 2008/0000970 A1
(43) Pub. Date: Jan. 3, 2008

(54) System and method for network-based talent contest

(76) Inventors: Kent Allen Savage, Austin, TX (US); Wesley Schiesz, Austin, TX (US); Matthew Hovis, Austin, TX (US)

Correspondence Address: HAMILTON & TERRILE, LLP, P.O. BOX 203518, AUSTIN, TX, 78720, US

(21) Appl. No.: 11/771,215

(22) Filed: Jun. 29, 2007

Related U.S. Application Data
(60) Provisional application No. 60/817,763, filed on Jun. 30, 2006.

(51) Int. Cl. G07C 13/00

(52) U.S. Cl. 235/386; 705/12

(57) ABSTRACT

A talent contest management platform provides an interface for artists to submit video presentations and fans to view the video presentations through the Internet to allow fans to vote to select artist talent contest winners from plural contest stages, each stage having an associated content genre. A voting system accepts fan votes over predetermined time periods, such as through plural contest rounds, until finalists picked by voting perform for a final vote round, such as by a live webcast. The voting system ensures a fair and fraud-free contest winner selection by tracking fan registrations, monitoring fan votes and analyzing voting results to detect and address voting fraud.

### CROSS-REFERENCE TO RELATED APPLICATION

This application claims the benefit under 35 U.S.C. § 119(e) of U.S. Provisional Application No. 60/817,763, filed Jun. 30, 2007, entitled “Methodology and System Implementation of an Online Talent Contest” and naming Kent A. Savage as inventor, which is incorporated by reference in its entirety.

This application is related to application Ser. No. ______, filed concurrently herewith, entitled “System and Method for Network-Based Talent Contest,” (Attorney Docket No. FAM07000), and naming as inventors Kent A. Savage, Wesley Schiesz, and Matthew Hovis.

### BACKGROUND OF THE INVENTION

1. Field of the Invention

The present invention relates in general to the field of networked computer systems, and more particularly to a system and method for network-based talent contest.

2. Description of the Related Art

The entertainment industry is constantly struggling to locate the next big talent. Often, happenstance has more to do with an artist reaching fame than does any organized industry effort. Although artists who achieve fame typically capitalize on celebrity status to earn substantial sums, up-and-coming talent is typically at the mercy of the entertainment industry. A typical arrangement benefits the entertainment industry with a substantial portion of any early success for an artist. Of course, the entertainment industry often assumes most early financial risk and, often, loses a good deal of its investment on artists who never quite hit it big. In the end, the public has the most say on which artists succeed or fail, and public reaction to an artist is often unpredictable. Even where an artist has great talent, the whims of the public reign over who succeeds and who fails.

One way that the entertainment industry has traditionally attempted to locate new talent is through talent calls and talent shows. Individuals who respond to talent calls and talent shows are judged by “experts” who attempt to select talent with the best chance of acceptance by the public. Recently, reality television shows, such as Fox's American Idol show, have taken the notion of a talent show to a national level by televising live performances of artists in a talent contest. A panel of judges tours the country and selects artists from different locations based on individuals who show up to try out. The selected artists, generally less than a handful of the thousands who initially try out, are presented in live performances before a national television audience. The audience votes by text message for contestants so that the contestants are gradually weeded out over a series of shows. Although the public has input into the selection of the winning artist, the field of contestants is first narrowed by judges so that many talented artists are eliminated without a chance for public review. In addition, the live performances at scheduled broadcast times effectively restrict audience input to that portion of the public who are free to watch the program.

Wide acceptance of the Internet by the public has altered how artists interact with the entertainment industry. Many artists attempt to bypass traditional entertainment industry distribution channels by posting performances on-line for public viewing. Typically, the artists hope to sell albums by CD or electronic download to individuals who fine the performances on-line. In fact, gaining public acceptance in this manner has proven problematic for artists. For example, it is difficult for an artist to attract views to a network location by the public. Even where individuals surf to an artist's website, downloads of music prove frustrating due to inconsistent formats and unreliable download bandwidth. Many times, individuals will not review an artist's on-line presentation for a long enough time to determine if the artist's work is of interest to the individual. In any event, without public and reliable indications of the quality of an artist's performance, only truly dedicated music fans will search through artist offerings with enough dedication to sort the good from the bad.

### SUMMARY OF THE INVENTION

Therefore a need has arisen for a system and method which provides talent contest management with public participation.

A further need exists for a system and method that provides reliable and trustworthy selection of a talent contest winner with public participation.

In accordance with the present invention, a system and method are provided which substantially reduce the disadvantages and problems associated with previous methods and systems for exposing artists to the public. A talent contest management platform accepts artist performances and provides the artist performances to fans for review and voting in a networked environment. Fan voting determines a winner of the talent contest in the course of one or more contest rounds. Voting integrity is maintained by a voting system that monitors voting by registered fan voters and voting results to detect voting fraud.

More specifically, a talent contest management platform has an artist manager to accept artist performances, a fan manager to support fan interaction with artist performances, and a voting system to accept fan votes for selection of a contest winner, such as through plural contest rounds with an artist submitting a video performance for each round until the artist is eliminated by voting or advances to a final round. The talent contest spans plural stages with each stage having a genre of music. Targeted advertising to fans based on fan registration information and the stage genre viewed by the fan generates revenue to support the talent contest. Voting integrity is maintained by the voting system which limits fans from multiple registrations and from voting multiple times for an artist in a stage during a given talent contest round. The voting system monitors vote results to detect and correct patterns of voting fraud.

The present invention provides a number of important technical advantages. One example of an important technical advantage is that a structured network-based process is provided for submission, presentation, voting, vote tallying, round winner progression, voter fraud detection and live finalist broadcasting. Interactions of the public with artist presentations through the Internet create a virtual contest environment. Artists submit their creations through a web-based system and then watch as an audience of registered fans review and vote on the presentations. After progression through predetermined contest rounds, artists with the most votes are invited to a live webcast of a final round to select a contest winner in various genre and an overall “fenom” winner with on-line network-based voting.

Another technical advantage of the present invention is that the fairness of anonymous voting through the Internet is maintained by monitoring and correcting vote frauds, such as by automated voting scripts or robots that cast illegitimate votes. Fans and artists register for accounts through a multiple step process of authentication and verification before accounts activated. All voting that occurs on the talent contest website requires that the user be logged in with a valid account. Voting is recorded and tracked with voting results automatically monitored for fraudulent activity. For example, any IP address that accounts for greater than a predetermined number of votes in a stage or round of the talent contest are removed. Automated statistical analysis of votes and presentation views further isolates potential frauds so that fans and artists alike can have confidence in the fairness of the talent contest winner selection.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system architecture of a talent contest management platform that supports a networked talent contest;

FIG. 2A depicts a flow diagram of a process for managing a network-based talent contest;

FIG. 2B depicts an example time line for a network-based talent contest;

FIG. 3 depicts an example of networked computer systems that support a network-based talent contest;

FIG. 4 depicts a flow diagram of a process for accepting video talent submissions for a network-based talent contest;

FIG. 5 depicts a flow diagram of fan navigation through a talent contest presentation;

FIG. 6 depicts a flow diagram of fan navigation through talent contest stages based on talent video submission genre;

FIG. 7 depicts a flow diagram of artist navigation through administrative functions;

FIG. 8 depicts a block diagram of a voting system for detecting talent contest vote fraud; and

FIG. 9 depicts a flow diagram of a process for detecting talent contest vote fraud.

### DETAILED DESCRIPTION

A talent contest management platform provides a network-based vehicle for exposing artists to the public and selecting artists preferred by the public in a fair and transparent manner. A talent contest presented through the Internet supports direct public interaction with artists and a voting system to create a virtual talent filter that enables the market of public opinion to select preferred artists based on artist talent submission video presentations. The public, not entertainment industry judges, select talent contest winners by popular vote in a series of voting rounds and through a plurality of talent contest stages that highlight a variety of genre, such as rock, country, hip hop or other publicly recognized music categories. Selectable viewing by the on-line audience of fans provides an always-available approach that encourages public involvement in the talent selection process, such as by random presentation of thumbnails, selection based on most viewed, alphabetical selection, selection based on the number of fans of an artist, and selection based on genre stages. Advertising based on the selections made by a fan allows advertising information to be directed to desired audiences to provide revenue in support of the talent contest. For example, advertising directed by genre selections, zip code, music preference, age, gender and other factor are possible based on user registration information and navigation history.

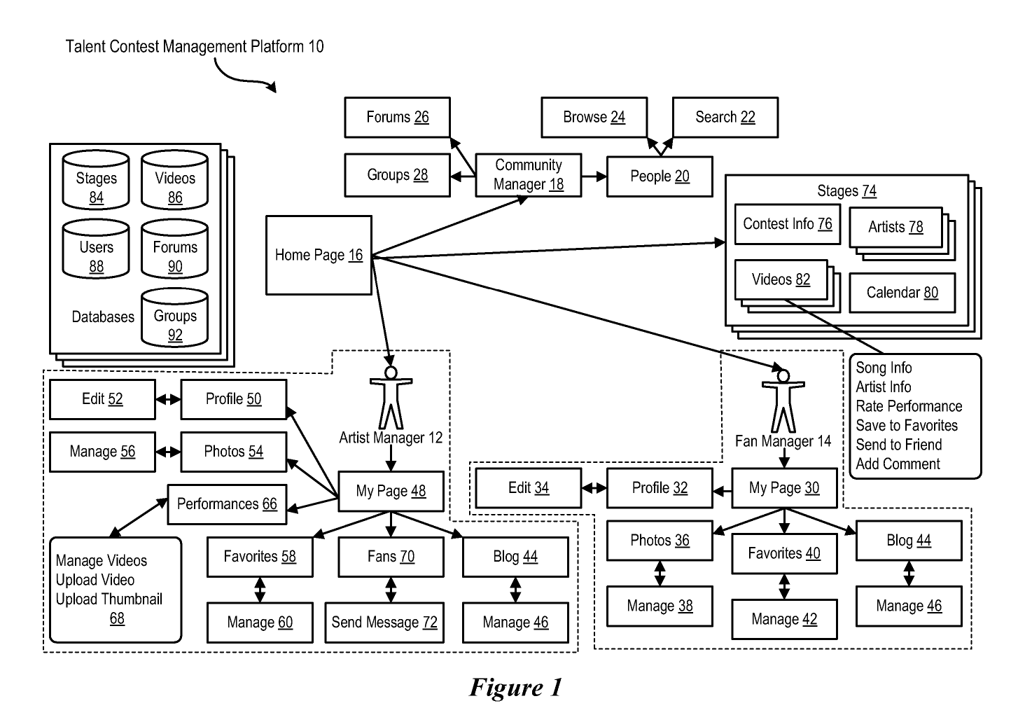

Referring now to FIG. 1, a block diagram depicts a system architecture that supports a networked talent contest. A talent contest management platform 10 is built with software tools, such as an object oriented architecture having C++ modules, to accept talent submissions from artists with an artist manager 12 for presentation to fans with a fan manager 14 who determine a talent contest winner by placing on-line votes. End users access talent contest management platform 10 through a home page 16 made available through a network, such as the Internet. From home page 16, the end user may proceed as to artist manager 12 or a fan manager 16 to manage individualized information or may proceed to a community manager 18 that supports communication with other end users. For example, with community manger 18, an end user communicates with other end users on an individual basis at a people section 20 with individuals located by a search function 22 or a browse function 24. As another example, within community manager 18, an end user communicates with other individuals in a forum section 26 that, for instance, defines multiple forum-based chat rooms around predefined or user-defined topics. As another example, with community manager 18, an end user communicates with other individuals in a group section 28 that, for instance, groups end users by areas of interest.

Fans who enter at home page 16 to fan manager 14 are provided with an individually-defined user area stored at a fan my page 30. Fan my page 30 provides access to a fan profile 32 and fan profile editing function 34 so that a fan has an option to post information about himself that is accessible to other end users. In addition to fan profile 32, a fan posts images of herself in a photo section 36 supported by a photo managing function 38. A fan's navigation through areas of interest is aided by a favorites section 40 that stores a list of areas of interest kept by a favorites manage function 42 that allows a fan to mark areas of interest for return visits. A fan is provided with a blog section 44 so that the fan can keep a journal accessible by other end users as defined with a blog manage function 46. Although an end user may elect not to set up and use a fan my page 30, doing so provides convenience and an opportunity for increased interaction and involvement with ongoing talent contests.

Artists who enter artist manager 12 through home page 16 are provided with an individually-defined user area stored at an artist my page 48. Arts are provided with many of the same conveniences available to fans, such as an artist profile 50 supported by a profile editing function 52, a photo section 54 supported by a photo managing function 56, a favorites section 58 supported by a favorites managing function 60 and a blog section 62 supported by a blog manage function 64. In addition, artists are provided with the ability to upload and manage performances and the ability to communicate with fans. A performance section 66 allows an artist to enter a talent contest by managing and uploading video of performances that are available for review by fans. A performance management function 68 accepts videos of performances as well as thumbnails that are used to support fan searches for desired performances. A fans section 70 manages interactions by an artist with fans with a send message function 72 so that artists and fans may interact directly.

Presentation of talent contest submissions is managed through one or more stages 74 that are, for instance, divided based on the genre of the talent contest submissions. From a stage 74, an end user has access to contest information 76 that explains the talent contest format and rules for participation by artists and fans. An artist list 78 provides fans with access to search artists based on artists' postings. A calendar 80 provides easy access to key dates, such as deadlines for artist submissions and fan voting. Artist submissions are available as videos 82 presented at the stage 74 of the artist genre. Videos 82 have associated song and artist information and are rated by end users who view a video. In addition, an end user can save a video as a favorite, send a video to another end user for viewing and add a comment associated with a particular video. Information accessible by end users is saved in a series of databases, such as a stage database 84, a video database 86, a user database 88, a forum database 90 and a group database 92.

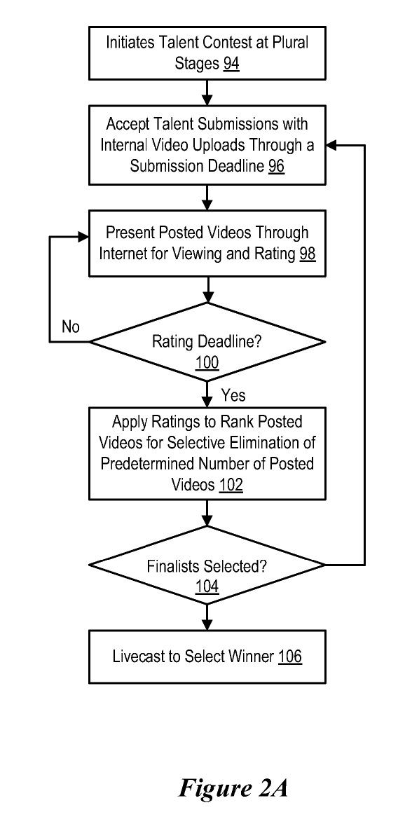

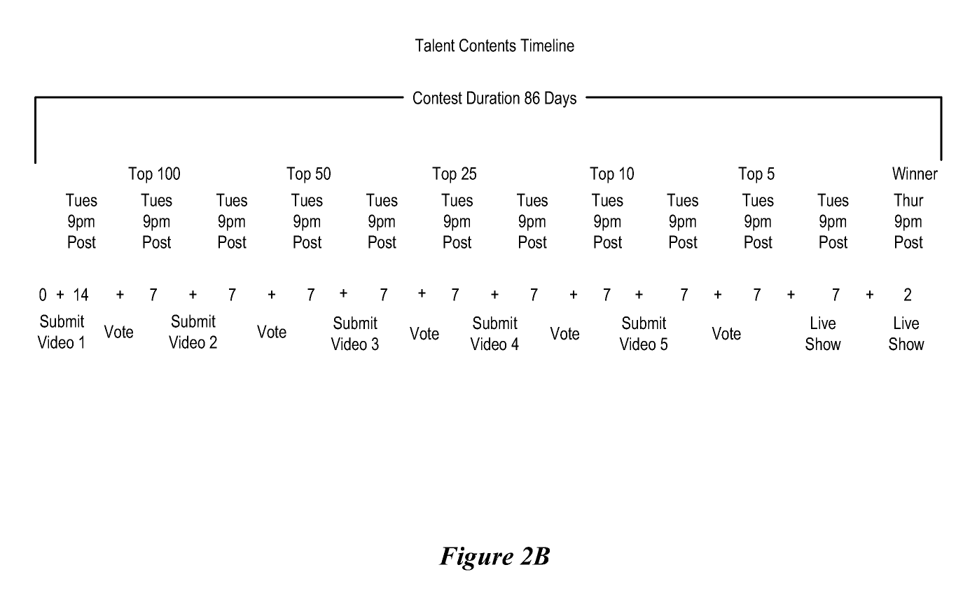

Referring now to FIG. 2A, a flow diagram depicts a process for managing a network-based talent contest. The process begins as step 94 with initiation of a talent contest at plurals stages. Initiation of a talent contest is, for example, announced at a home page so that artists may begin to upload talent submission videos to enter the talent contest in desired genre. At step 96, talent submissions are accepted with video uploads through the Internet until a talent submission deadline is reached. At step 98, talent submission videos posted before the submission deadline are made available for presentation to fans who submit votes for preferred submissions based upon genre of the submissions. For example, a fan is allowed to select a single talent submission in each genre to receive that fan's vote up through a voting deadline. At step 100, a determination is made of whether a voting deadline has passed, and if not, the process returns to step 98 to continue accepting votes. If a voting deadline is reached, the process continues to step 102 to apply ratings made by fans to selectively eliminate a predetermined number of talent submissions. At step 104, a determination is made of whether the remaining non-eliminated talent submissions are finalists or if additional eliminations are to be made. If the remaining talent submissions are not finalists, the process returns to step 96 to accept new talent submissions from the non-eliminated artists. If at step 104 the remaining talent submissions represent finalists in the talent contest, the process continues to step 106 for a livecast made over the Internet of the finalists and a final vote to select the talent contest winner. FIG. 2B presents an example of a timeline of multiple voting rounds that narrows talent submissions to a list of finalists leading up to a finalist Internet livecast.

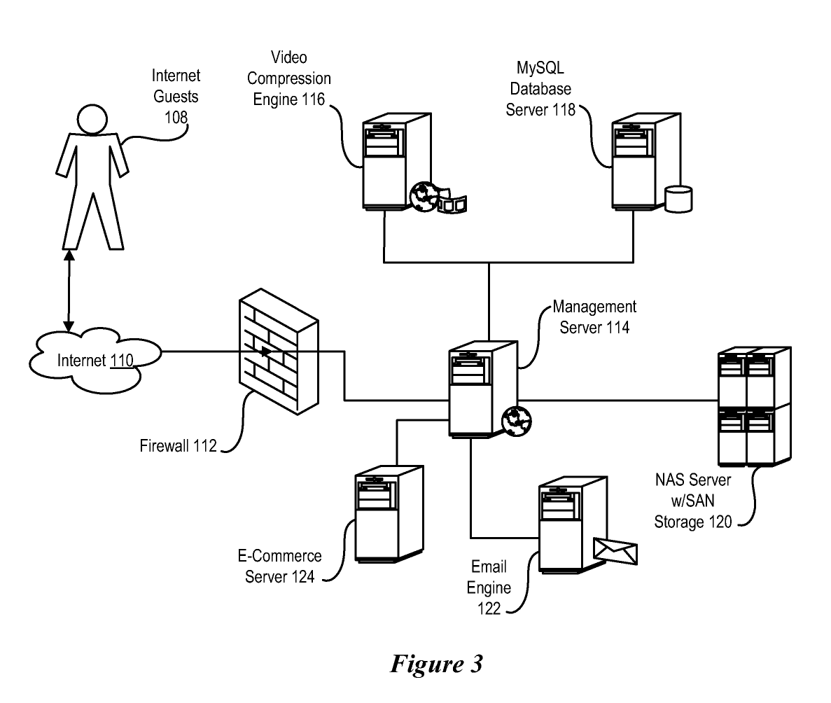

Referring now to FIG. 3, an example of networked computer systems is depicted to support a network-based talent contest. An Internet guest 108 uses a browser or other network tool to navigate through Internet 110 and past a firewall 112 to a management server 114. Management server 114 is the primary entry point for guests 108 and is the residing home of application code files that provide guest access. A video compression server 116 interfaced with management server 114 is the point of entry for guests to upload video talent submissions. Video compression server 116 looks for uncompressed video files from user uploads and, when an uncompressed video file is located, compresses from any video format to a Flash (FLV) format. A MySQL database server 118 interfaces with management server 114 to store video and other uploads are respond to guest searches for retrieval of desired stored information in a rapid manner. Database server 118 is, for example, a RAID5 array with 3 GB/sec SAS drives that give rapid responses to SQL database inquiries. An NFS server 120 with SAN storage provides a front end to a SAN infrastructure so that mount points are available at any systems in the network to provide efficient scaling as storage needs grow. For example, dual HBA connectors provide daisy chaining of additional SAN units so that storage space grows as needed. An e-mail server 122 handles outgoing e-mail from user-generated site content, such as automated notices regarding the status of contestant submissions. An e-commerce server 124 interfaced with management server 114 allocates advertising information and other e-commerce functions as needed to contest content. For example, e-commerce server 124 targets advertising content presented along with fan reviews of talent submissions so that predetermined genre have desired advertising content presented with it. Targeted advertising based on the genre of contest content or other factors has increased value to advertisers and provides enhanced revenue to support the talent contest.

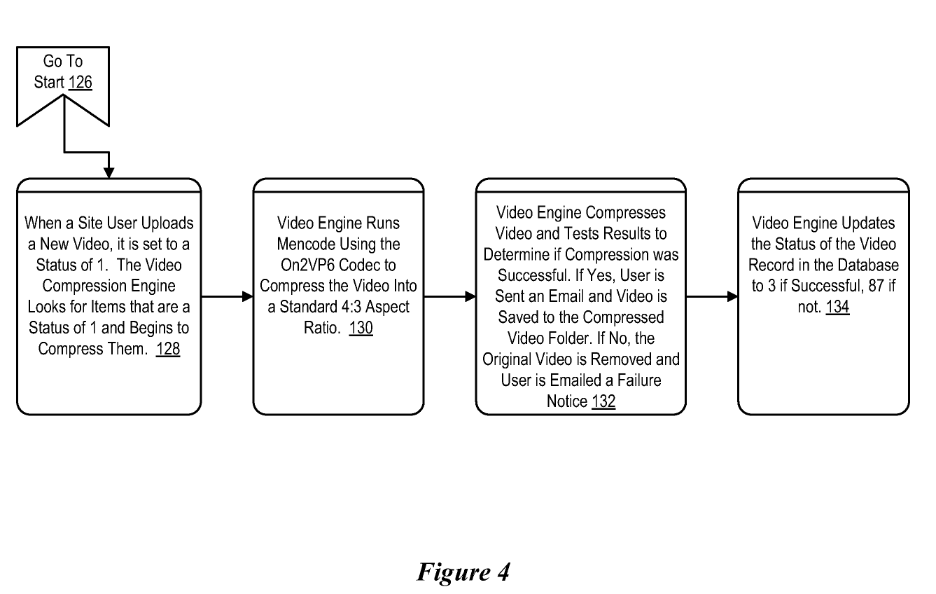

Referring now to FIG. 4, a flow diagram depicts a process for accepting video talent submissions for a network-based talent contest. The process begins at step 126 with detection of an upload of video by an artist. At step 126, a status value of 1 is assigned when a site user uploads a new video talent submission. Video compression engine 116 searches for items with a status value of 1 and, when an item with a status value of 1 is detected, initiates video compression. At step 130, video compression engine 116 runs Mencode using an On2VP6 Codec, or a similar application and Codec combination, to compress the video with the status of 1 into a standardized 4:3 aspect ratio. At step 132, video engine 116 compresses the video and tests the resulting compressed video file to determine if the compression was successful. If the compression is successful, then an e-mail message is sent by e-mail engine 122 to the artist associated with the video to indicate a successful compression and the compressed video is save to SAN server 120. If the compression is not successful, then the video is deleted and a message is sent to the artist indicating an unsuccessful compression. At step 134, the status of a successfully compressed video is updated in the database to a value of 3 and the status of an unsuccessfully compressed video is updated to a value of 87.

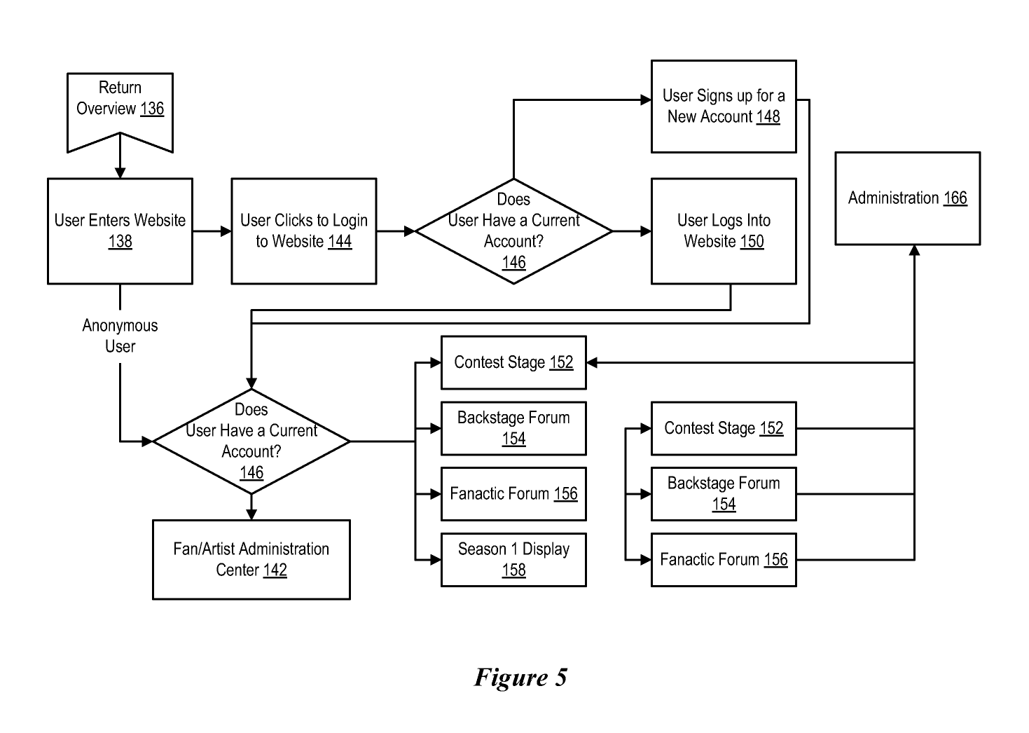

Referring now to FIG. 5, a flow diagram depicts fan navigation through a talent contest presentation. The process begins at step 138 with navigation to an entry point, such as the network-based talent contest home page through the Internet. At step 138, the fan enters the talent contest web page and can choose to navigate as a registered user or as an anonymous user having reduced access rights. If the fan navigates as anonymous user, the process continues to step 140 for the user to select a navigation path, including navigation at step 142 to a fan/artist administration center having information about the talent contest. An anonymous user who navigates to other locations of the website lacks rights to post messages or vote, but may view talent contest videos. If, at step 138, the end user elects to navigate as a registered user, the process continues to step 144 for presentation of a login page. At step 146, the user indicates whether she has a current account and, if not, the process continues to step 148 to allow the user to sign up for a new account. If at step 146 the end user indicates that he has a current account, the process continues to step 150 to allow the user to login to the website. From steps 148 and 150, the process continues to step 140 to provide the user with navigation paths.

At step 140, a fan selects a desired navigation path to view information of interest. Navigation to a contest stage at step 152 presents talent contest content for current talent contests. For example, a fan views talent video submissions by genre by selecting a stage with a desired genre. Navigation to contest stage 152 presents contest video submissions for artists who are active contestants eligible to receive votes to advance in the talent contest. Navigation to step 154 brings a fan to a backstage forum having content and discussions regarding the artists and the current state of the talent contest. Navigation to fanatic forum at step 156 directs a fan to content specific for artists who the fan desires to follow as a “fanatic”. Navigation at step 158 to a season 1 display presents content from previous talent contests, such as videos for previous talent contest entries. While navigating content, fans who have logged in under a current account may also elect to navigate to a variety of other functions. For example, a fan who navigates at step 160 to a voting system may place a vote for a talent contest video submission in each genre. A fan may navigate at step 162 to a comment or chat system to engage in electronic communication with other fans or with artists. Alternatively, a fan may navigate to a user forum at step 164 to engage in electronic communication or review content for specific forums. A fan who needs administrative help or seeks general information regarding talent contest rules may navigate to step 166 to seek administrative help.

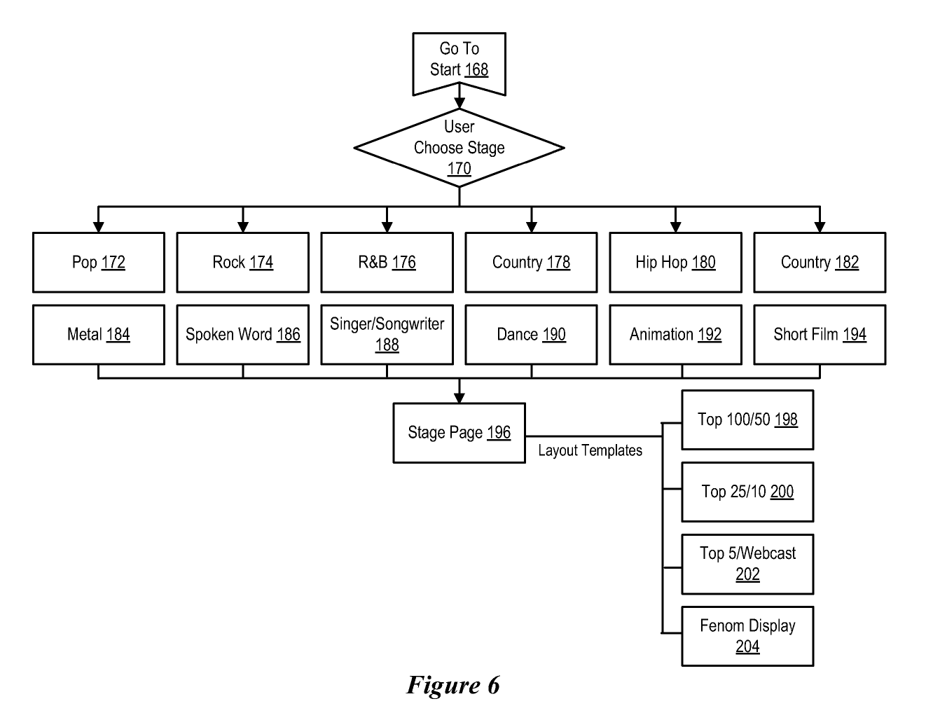

Referring now to FIG. 6, a flow diagram depicts fan navigation through talent contest stages based on talent video submission genre. The process begins at step 168 with fan selection of talent contest navigation. At step 170, the end user is presented with a variety of stage choices for selection of a desired type of contest submission content. The alternatives presented by FIG. 6 include a pop stage 172, a rock stage 174, a rhythm and blues stage 176, a country stage 178, a hip hop stage 180, a country stage 182, a metal stage 184, a spoken word stage 186, a singer/songwriter stage 188, a dance stage 190, an animation stage 192 and a short film stage 194. In alternative embodiments, other types of stages may be presented based upon fan preferences. Once a fan selects a stage, the process continues to step 196 for population of a stage page with the stage content selected by the end user. Use of a common stage page template populated by selected stage content simplifies end user navigation through a variety of content by presenting content from different stages in a consistent manner. For example, during population of the stage page at step 196, a predetermined number of video talent submissions are presented to the end user based on a predetermined selection criteria, such as a random presentation, a most-viewed list or other criteria. From population of the stage page at step 196, the process continues to steps 198 through 204 based upon the state of the talent contest. At step 198, the stage page is populated for a template that manages 100 or 50 contestants, such as a template that manages presentation of random talent submission videos or that supports more extensive search criteria for a greater number of contestants. At step 200, the stage page is populated for a template that manages 25 or 10 contestants, a more limited number experienced as the talent contest progresses so than more detailed information on contestants may be included. At step 202, the stage page is populated for a template that manages 5 contestants, such in preparation for final competition at or after a live cast. At step 204, a “fenom” display template is populated for contestants whose performance has met predetermined criteria that indicates phenomenal popularity for a contestant.

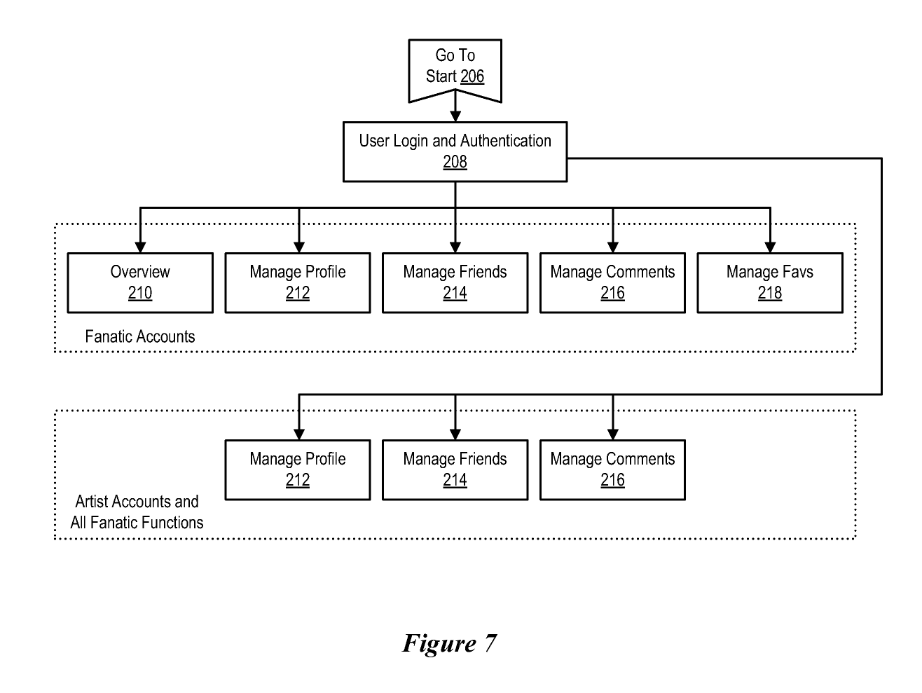

Referring now to FIG. 7, a flow diagram depicts artist navigation through administrative functions. Artist navigation begins at step 206 with a request for access to artist functions and continues to step 208, at which an artist enters a login and authentication to establish a status as an active artist. After login authentication, the artist is provided with a number of alternative navigation for management of fanatic accounts related to managing fan interactions and artist accounts. At step 210, the artist is provided with an overview of options available for managing fan interactions. One option, at step 210, manages the artist profile that is provided for fans to review, such as the artists' works and accomplishments. Another option at step 214 manages fans who have registered as friends of the artist, such as by providing e-mail or other updates to desired friends or to block or remove undesired friends. Another option is to manage comments directed to the artist or posted at the artist's blog or fan comment billboards. A manage “favs” option at step 218 allows the artist to update links to favorite locations at the talent contest network location or at other Internet locations. Accounts available for management include management of videos at step 220, such as posting new videos for submission at the talent contest or other videos designed to entertain or inform fans. An artist manages one or more Blogs at step 222 that allow the artist to keep a journal regarding the talent contest. An artist is provided with administrative ability to manage fans at step 224, such as by blocking fans who are not friends from access to the artist's fanatic resources.

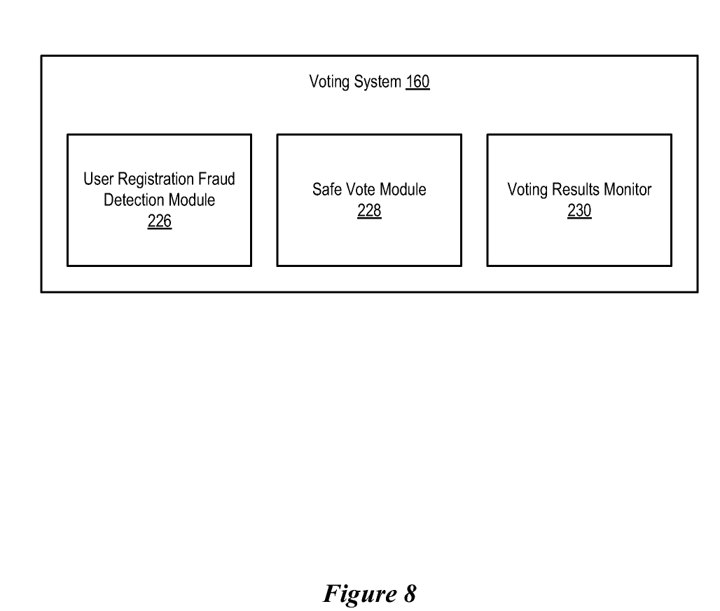

Referring now to FIG. 8, a block diagram depicts a voting system 160 for detecting talent contest vote fraud. A first layer of fraud detection is provided by a user registration fraud detection module 226 which detects attempts by a user to register for multiple accounts that would allow multiple votes by the user. User registration fraud detection module 226 authenticate and tracks e-mail accounts input by users at each new user account sign up to ensure that only one talent contest account is allowed for each e-mail account. During registration of a new talent contest account, the registering end user is required to input a unique e-mail account and a CAPCHA code that helps to foil automated systems designed to register multiple accounts. User registration fraud detection module 226 also tracks the IP address and user agent for each talent contest account to limit the number of new accounts that can register from the same IP address in a given time period, such as a maximum of 15 accounts per day. A safe vote module 228 tracks votes by user account, IP address and user agent so that a predetermined number of votes are allowed for an artist from each account, such as one vote per artist per account. Safe vote module 228 then filters out votes under predetermined conditions, such as when a predetermined number of votes for an artist are placed. For example, if more than ten percent of votes originate from an IP address for a season, stage or round, those votes are not considered. A voting results monitor 230 tracks all votes placed and scans for fraud patterns, such as by comparing views of an artist video submission against votes for the artist based on the video submission. Such a comparison might also include the proximity in time between votes and views and the IP addresses that made the views versus the IP addresses that placed the votes. An administrator has authority to investigate and nullify votes based on fraudulent voting patterns as well as to deactivate users associated with fraudulent voting patterns.

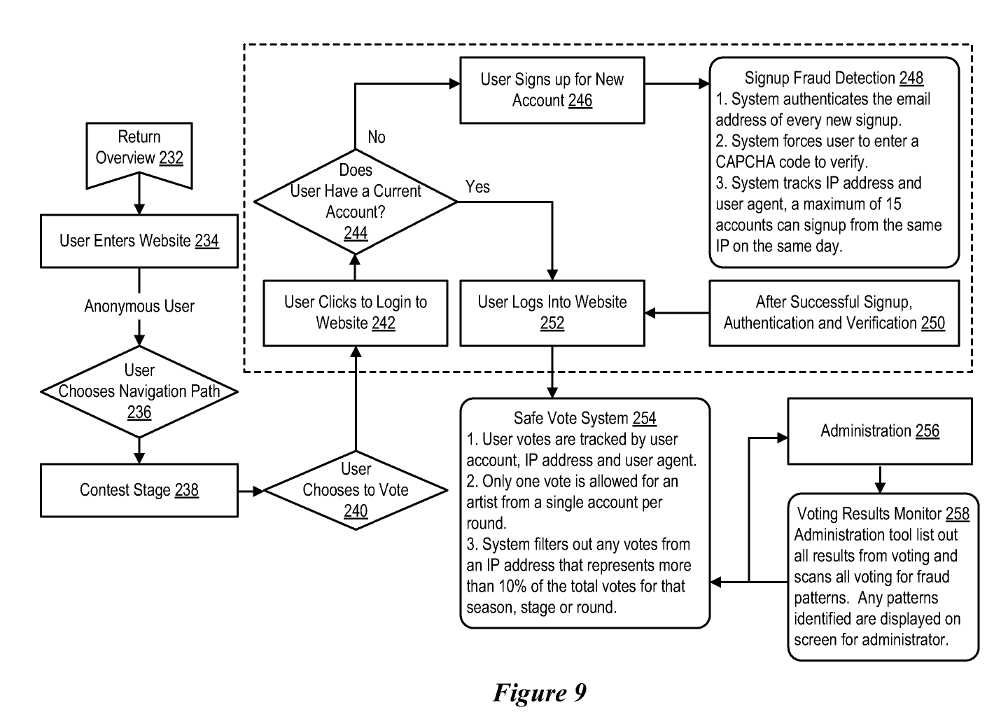

Referring now to FIG. 9, a flow diagram depicts a process for detecting talent contest vote fraud. The process begins at step 232 with fan entry to the talent contest website at step 234 as an anonymous user. At step 236, the user selects a navigation path to proceed at step 238 to the contest stage. From the contest stage, at step 240 the user elects to place a vote. Once an anonymous user attempts to place a vote, the process continues to step 242 to present the user with an option to login to the website. If, at step 244, the user lacks a current account, the process continues to step 246 to present the user with a page to accept new user account information. The new user account information is forwarded at step 248 to the user registration sign-up fraud detection module for analysis. The system authenticates the e-mail address of each new account registration, such as by sending an e-mail to the address and requiring a response from that e-mail. The system forces the user to verify the response to the e-mail by replying with a manually input visual code, such as CAPCHA code that includes visually recognizable letters and numbers that are not recognized electronically by a computer. The system also tracks IP addresses and user agents associated with new registrations over a predetermined time period to limit the number of new accounts from any given IP address and user agent, such as a maximum of 15 accounts per day. After a successful sign up of a new account at step 250 the process continues to step 252 to log the user into the website. Users who have an active account at step 244 proceed to step 252 to login using the active account.

Once a user is logged in, the user proceeds to a safe vote system at step 254 to analyze the user vote for indications of fraud. User votes are tracked by user account, IP address and user agent. Only one vote is allowed for an artist for a single account during a talent contest elimination round so that the artist who accumulates the most number of votes wins the round. The safe vote system filters out any votes from an IP address that represents more than a predetermined portion of the total votes for that season, stage or round, such as more than ten percent of the votes cast. The results of the safe vote system are forwarded at step 256 to an administrator who monitors corrective actions. At step 258, the administrator may also monitor voting results based on other parameters, such as automated statistical analysis of voting results. Any additional fraudulent voting patterns that are identified can be applied to take corrective actions to ensure the validity of the vote count. Analysis of voting results may consider a variety of factors, such as comparisons between the number of views for an artist video submission and the number of votes for that submission, the IP address of the views and the submissions, the timing relationship between views and submissions or other patterns that indicate input of fraudulent votes. For example, if an artist submission receives more votes than views or votes from IP addresses not associated with views, fraud is indicated. Similarly, if an artist receives multiple votes in a time period without having a reasonably related number of views, fraud is indicated.

Although the present invention has been described in detail, it should be understood that various changes, substitutions and alterations can be made hereto without departing from the spirit and scope of the invention as defined by the appended claims.

What is claimed is:

1. A voting system for counting votes placed over a network, the voting system comprising:
a registration fraud detection module operable to detect multiple registrations by a common user through the network;
a safe vote module operable to analyze registrations by plural users to detect multiple votes placed by a common user through the network; and
a voting results monitor operable to analyze vote results for votes placed through the network to detect patterns associated with voting fraud.

2. The voting system of claim 1 wherein the registration fraud detection module detects multiple registrations by:
requiring a message address from a user at registration by the user;
sending a message to the message address; and
requiring a response from the message address to authenticate the registration.

3. The voting system of claim 2 wherein the message sent to the message address comprises a visual code and the response from the message is authenticated by including the visual code.

4. The voting system of claim 3 wherein the visual code comprises a CAPCHA code.

5. The voting system of claim 1 wherein the registration fraud detection module detects fraud by:
tracking the IP address from which users request registration; and
limiting the number of registrations accepted from any one IP address.

6. The voting system of claim 1 wherein the safe vote module analyzes registrations by tracking the number of votes associated with any one IP address.

7. The voting system of claim 1 wherein the voting results monitor analyzes vote results by comparing user views of artist submissions and user votes for artist submissions.

8. The voting system of claim 7 wherein comparing user views and user votes further comprises comparing the number of user views for an artist submission and the number of user votes for the artist submission.

9. The voting system of claim 7 wherein comparing user views and user votes further comprises comparing the time at which user views occur of an artist submission and the time at which user votes occur for the artist submission.

10. The voting system of claim 7 wherein comparing user views and user votes further comprises comparing the IP address of user views of an artist submission and the IP address of user votes for the artist submission.

11. A method for detecting voting fraud for votes placed over a network for talent contest artist submissions, the method comprising:
monitoring user registrations to detect multiple registrations by a user;
analyzing user votes to detect multiple votes by a user for any one artist submission; and
analyzing vote results to detect patterns of fraud.

12. The method of claim 11 wherein monitoring user registrations further comprises:
requiring a message address from a user at registration by the user;
sending a message to the message address; and
requiring a response from the message address to authenticate the registration.

13. The method of claim 12 wherein the message sent to the message address comprises a visual code and the response from the message is authenticated by including the visual code.

14. The method of claim 13 wherein the visual code comprises a CAPCHA code.

15. The method of claim 11 wherein monitoring user registrations to detect multiple registrations by user further comprises:
tracking the IP address from which users request registration; and
limiting the number of registrations accepted from any one IP address.

16. The method of claim 11 wherein analyzing user votes to detect multiple votes by a user further comprises tracking the number of votes associated with any one IP address.

17. The method of claim 11 wherein analyzing vote results to detect fraud patterns further comprises comparing user views of artist submissions and user votes for artist submissions.

18. The method of claim 17 wherein comparing user views of artist submissions and user votes for artist submissions further comprises comparing the number of user views for an artist submission and the number of user votes for the artist submission.

19. The method of claim 17 wherein comparing user views of artist submissions and user votes for artist submissions further comprises comparing the time at which user views occur of an artist submission and the time at which user votes occur for the artist submission.

20. The method of claim 17 wherein comparing user views of artist submissions and user votes for artist submissions further comprises comparing the IP address of user views of an artist submission and the IP address of user votes for the artist submission.
